(19) United States
(12) Patent Application Publication
(10) Pub. No.: US 2018/0056715 A1
(43) Pub. Date: Mar. 1, 2018

(54) CYLINDER FOR REMOVAL, STORAGE, AND ATTACHMENT OF LUG NUTS

(71) Applicant: Mary Donna Enborg, N. Las Vegas, NV (US)

(72) Inventor: Mary Donna Enborg, N. Las Vegas, NV (US)

(21) Appl. No.: 15/452,410

(22) Filed: Mar. 7, 2017

Related U.S. Application Data
(60) Provisional application No. 62/495,047, filed on Sep. 1, 2016.

(51) Int. Cl. B60B 29/00; B25B 23/10

(52) U.S. Cl. CPC B60B 29/003; B25B 13/461; B25B 23/108

(57) ABSTRACT

A tool is provided comprising an open cylinder, a socket at a first end of the cylinder, a square-shaped opening at a second end of the cylinder, a lengthwise chamber inside the cylinder with dimensions of the socket, an open slot lengthwise along the cylinder, a plurality of rectangular open slots disposed perpendicularly along the lengthwise open slot, a pushing mechanism disposed inside the chamber, a tab disposed to join the pushing mechanism for setting a position of the pushing mechanism and at least one ball bearing disposed inside the chamber proximate the first end, whereby the socket is in a shape of a wheel lug nut and is directed to removing and attaching said lug nut, and whereby the cylinder holds a plurality of said lug nuts at least during changing of at least one tire of a vehicle.

### CROSS-REFERENCE TO RELATED APPLICATIONS

The present Utility patent application claims priority benefit of the U.S. provisional application for patent Serial No. 62/495,047 filed 1 Sep. 2016 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a device for removing, storing and attaching lug nuts to a wheel. More particularly, certain embodiments of the invention relates to a metal or plastic hollow cylinder with a hexagonal socket at one end and a square opening at the other end that allows for the socket to remove and attach lug nuts, the square opening to be joined with a ratchet or other tool, and for the cylinder with internal sliding mechanism to securely store lug nuts, for example while a user is replacing a tire.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that lug nuts are internally threaded metal objects used to affix a wheel holding a tire to a vehicle. One rounded or conical (tapered) end is used on steel and most aluminum wheels. A set of lug nuts are typically used to secure a wheel to threaded wheel studs and thereby to a vehicle's axles.

Removing a flat tire and replacing it with a spare tire can be a dangerous and stressful activity. A flat tire may occur at any time and the driver may have little choice as to where to stop the affected vehicle. Roadsides are inherently dangerous with speeding vehicles passing closely, limited visibility, and unfavorable pavement and curb conditions. Changing a tire at night and during inclement weather further adds to the danger.

Flat tires occur on average at least once a year to every household with an automobile. Tire manufacturers have made improvements over the years. For example, about 15 percent of all new cars come with run-flat tires—tires that can be driven upon until reaching a stopping point for changing. While run-flat tires are an improvement, they and other modifications to the field don't address the problem itself: a flat tire must be changed.

Flat tires almost always occur on the road while driving—and in all locations, at all times of day, in all seasons of the year, and in all types of weather. These circumstances make the procedure more difficult. The experience can be exhausting, too. Even for those experienced in the procedure, a tire change takes 20 minutes on average. It is not complicated, but the physical task of changing a tire is consuming.

Lug nuts can be lost in the stress, confusion and danger of a flat tire. When one stud is without a needed lug nut, the pressure that tire places on the other studs can greatly increase while driving. That additional pressure loosens the other lug nuts, especially those directly next to the stud that is missing its lug nut.

Not only does driving with one stud without its lug nut pose risk of creating the same flat-tire circumstance all over again, but it creates even worse problems. That poorly applied tire will vibrate. The vibration damages the tire rim. It also damages the studs, causing them to bend and even break off.

Driving with a lug nut missing makes the vehicle harder to operate as well. The uneven pressure upon the tire that results from a missing lug can make the car wobble while travelling. Not only does this affect the vehicle's alignment, causing another problem in need of costly repair, but it makes the car difficult to steer and control. Anytime a driver can't properly control the vehicle, the driver is much more likely to have an accident.

Having a flat tire can be bad, but the problems that can occur when changing that flat can be worse. Every year, approximately 7,800 vehicle accidents in the U.S. occur with vehicles that are stopped for a tire-change. Flat tires can occur anywhere at any time, of course, but drive-time in the U.S. is typically on high-speed highways. Such highways are where 74 percent of those accidents involving vehicles changing tires occur. In almost half of those incidents (over 3,400), an injury occurs. Sadly, 138 Americans are killed in these specific accidents every year.

In view of the foregoing, it is clear that these traditional techniques are not perfect and leave room for more optimal approaches.

### BRIEF DESCRIPTION OF THE DRAWING

The present invention is illustrated by way of example, and not by way of limitation, in the figures of the accompanying drawings and in which like reference numerals refer to similar elements and in which:

FIG. 1 illustrates two instances of an exemplary cylinder for removing, storing and attaching lug nuts according to an embodiment of the present disclosure with lengthwise slot, rectangular openings, portion of a t-tab of a pushing mechanism, and spring-loaded bearing depicted.

FIG. 2 illustrates an instance of an exemplary cylinder according to an embodiment of the present disclosure with rubber strips embedded in the side of the cylinder to provide grip as well as the t-tab with texture to aid a user in pushing and pulling on the t-tab.

FIG. 3 illustrates an instance of an exemplary cylinder with a hexagonal-shaped interior chamber of the cylinder depicted including two spring-loaded bearings, a sliding plate of the pushing mechanism, a durable spring of the pushing mechanism and the t-tab of the pushing mechanism.

FIG. 4 illustrates two instances of an exemplary cylinder with close-up views of the lengthwise slot, rectangular openings, and portion of the t-tab with the t-tab in an up and locked position in one view and in a down and unlocked position in the other view wherein down position indicates that the pushing mechanism can be moved lengthwise within the chamber.

FIG. 5 illustrates two instances of an exemplary cylinder providing two see-through views of the cylinder with four lug nuts stored in the top view and two lug nuts stored in the bottom view and the pushing mechanism appropriately positioned for both quantities of stored lug nuts.

FIG. 6 illustrates an instance of an exemplary cylinder in which the cylinder is depicted in the process of use with an air impact wrench.

FIG. 7 illustrates an instance of an exemplary cylinder in which a ratcheting tire tool is attached to the cylinder and is the process of removing and attaching a lug nut.

FIG. 8 illustrates an instance of an exemplary cylinder in which a tire iron is integral to the cylinder, the tire iron exhibiting a handle with a rubberized, textured sleeve and a long, hard shaft.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms”exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of excludes any element, step, or ingredient not specified in the claim. When the phrase “consists of (or variations thereof) appears in a clause of the body of a claim, rather than immediately following the preamble, it limits only the element set forth in that clause; other elements are not excluded from the claim as a whole. As used herein, the phase “consisting essentially of and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of or “consisting of a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of or, alternatively, by “consisting essentially of”, and thus, for the purposes of claim support and construction for “consisting of format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of systems and methods for removing lug nuts while changing a tire of a vehicle that may be provided by preferred embodiments of the present invention. In some embodiments, a cylinder with socket for the removal and application of tire lug nuts, the cylinder configured to store said lug nuts within its interior chamber during the removal and application process.

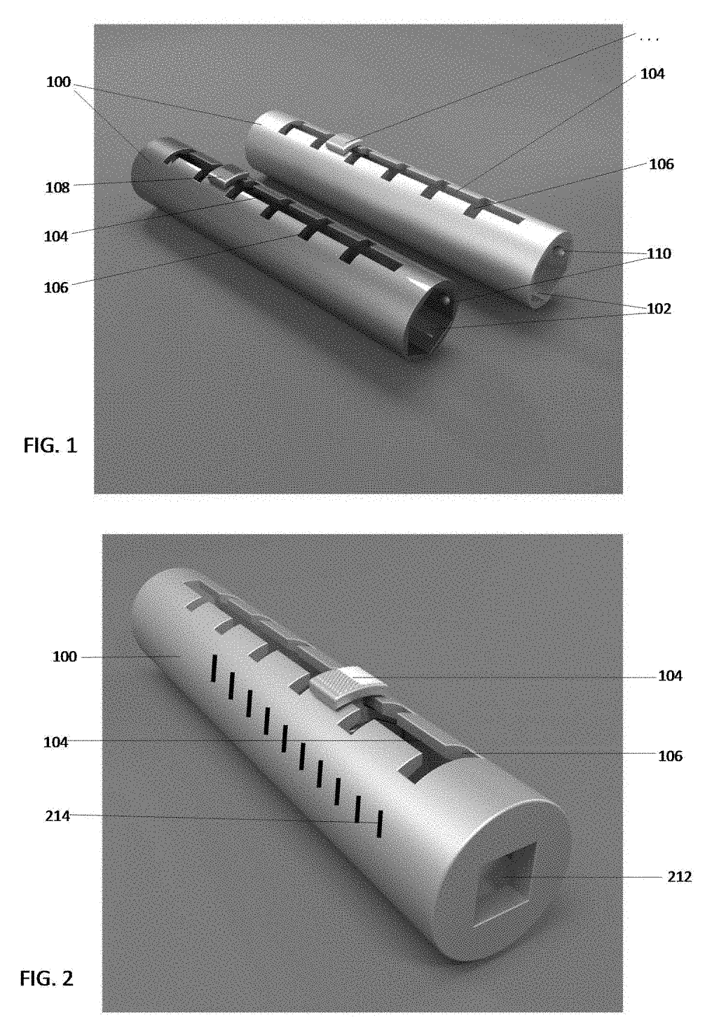

FIG. 1 illustrates two instances of an exemplary cylinder 100 for removing, storing and attaching lug nuts according to an embodiment of the present disclosure with lengthwise slot 104, rectangular openings 106, portion of a t-tab 108, and spring-loaded bearing 110 depicted. Also depicted is an interior chamber 102 of the cylinder 100. The t-tab 108 may also be referred to interchangeably as the tab 108. While not enumerated in FIG. 1, the term socket as used herein indicates the open hexagonal end of the chamber 102 into which a lug nut may fit for removal or attachment to a wheel.

The cylinder 100 stores tire lug nuts within its chamber 102 while the cylinder 100 is being used to remove and/or apply said lug nuts. An objective is to prevent the loss/misplacement of lug nuts during the tire changing process. Use of the cylinder 100 may allow tire changing to be completed faster and safer.

The cylinder 100 also features two spring-loaded bearings 110 at the entry point of its hexagonal chamber 102. These bearings 110 prevent lug nuts stored in the chamber 102 from accidently falling out. To get the lugs out the user must apply forward force to a pushing mechanism or place the socket on the lug of the tire and start to apply the lug. The forward pressure of the lug moving forward through the chamber 102 causes the bearings 110 to push into the sidewall of the socket and the lug can pass. As soon as the lug passes the bearings 110 pop back out to block the next lug from accidently falling out.

The depth of the chamber 102 can be controlled. The pushing mechanism, only partially depicted in FIG. 1 consists of the tab 108, a durable spring, and a sliding plate. This pushing mechanism can be moved along the lengthwise slot 104 to control the depth of the chamber 102. The tab 108 is pushed down out of the rectangular opening 106 of the slot 104, and then the pushing mechanism can be moved. Once the desired position is achieved the tab 108 is released and it will extend into the rectangular opening 106 to lock the pushing mechanism in place.

FIG. 2 illustrates an instance of an exemplary cylinder 100 according to an embodiment of the present disclosure with rubber strips 214 embedded in the side of the cylinder 100 to provide grip. The tab 108 may be textured to aid a user in pushing and pulling on the tab 108. These gripping features may be of value when the user has wet and/or greasy hands.

Also depicted in FIG. 2 is a square opening 212 at an opposite end from the socket that may be used for coupling with a manual tire tool, a ratcheting tire tool, or an air impact wrench. Such flexibility may make the cylinder 100 viable for both consumer and commercial use.

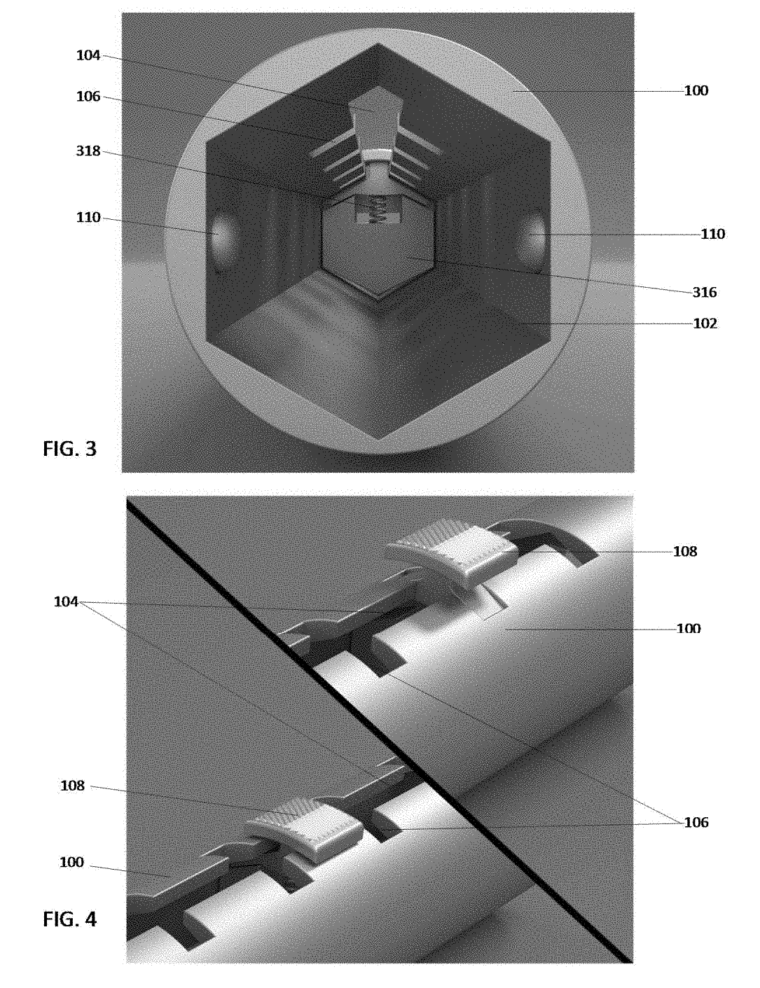

FIG. 3 illustrates an instance of an exemplary cylinder 100 with a hexagonal-shaped interior chamber 102 of the cylinder 100 depicted including two spring-loaded bearings 110, a sliding plate 316, and a spring 318.

The ball bearings 110 are spring loaded into the chamber 102 and prevent stored lug nuts from falling out of the cylinder 100 The sliding plate 316 restricts movement of lug nuts inside the chamber 102. The plate 316 is perpendicular to surfaces of the chamber 102 and is moveable inside the chamber 102 in accordance with a quantity of lug nuts inside the chamber 102. The plate 316 applies pressure against the lug nuts stored inside the chamber 102. The spring 318may be flexed and extended via action of the tab 108.

The plate 316 is held in position via the tab 108 and the spring 318. The tab 108, when depressed, promotes movement of the plate 316 within the chamber 102. Movement of the plate 316 within the chamber 102 one of extends and shortens depth of the chamber 102. Depth of the chamber 102 as set by the tab 108 and the plate 316 depends on a quantity of lug nuts disposed inside the chamber 102.

FIG. 4 illustrates two instances of an exemplary cylinder 100 with close-up views of the lengthwise slot 104, rectangular opening 106, and portion of the tab 108 with the tab 108 in up and locked position in one view and down and unlocked position in the other view. Up position of the tab 108 indicates that the plate 316 is engaged within the chamber 102 and cannot move, thus holding stored lug nuts steady.

When in the up and secured position, the tab 108 is held firm within the rectangular opening 106 chosen to provide such secure positioning of the tab 108 and holding of the stored lug nuts. When in its down and unlocked position, the tab 108 may be moved freely within the slot 104 and allows the plate 316 to be moved freely to desired position inside the chamber 102.

FIG. 5 illustrates two instances of an exemplary cylinder 100 providing two see-through views of the cylinder 100 with four lug nuts stored in the top view and two lug nuts stored in the bottom view. The tab 108 and plate 316 are appropriately positioned in each view for the quantities of stored lug nuts.

The quantities of rectangular openings 106 and positions for stored lug nuts inside the chamber 102 depicted in FIG. 5 and elsewhere are for discussion and illustration purposes. In embodiments, the quantities of rectangular openings 106 and positions for stored lug nuts inside the chamber 102 may be greater than or less than is depicted.

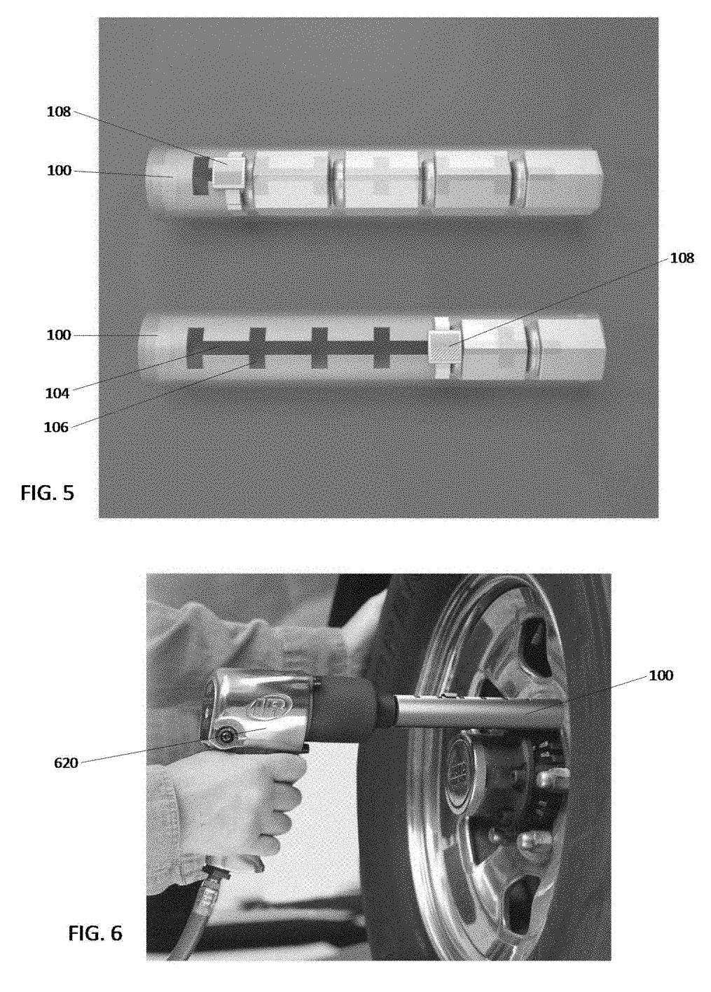

FIG. 6 illustrates an instance of an exemplary cylinder 100 in which the cylinder 100 is depicted in the process of use with an air impact wrench 620. As noted above, the opening 212 may be used to couple the cylinder 100 to devices such as the air impact wrench 620, a tire iron and a ratcheting tire tool such that lug nuts may be removed or attached to wheels. FIG. 6 depicts an individual using an air impact wrench during such activity.

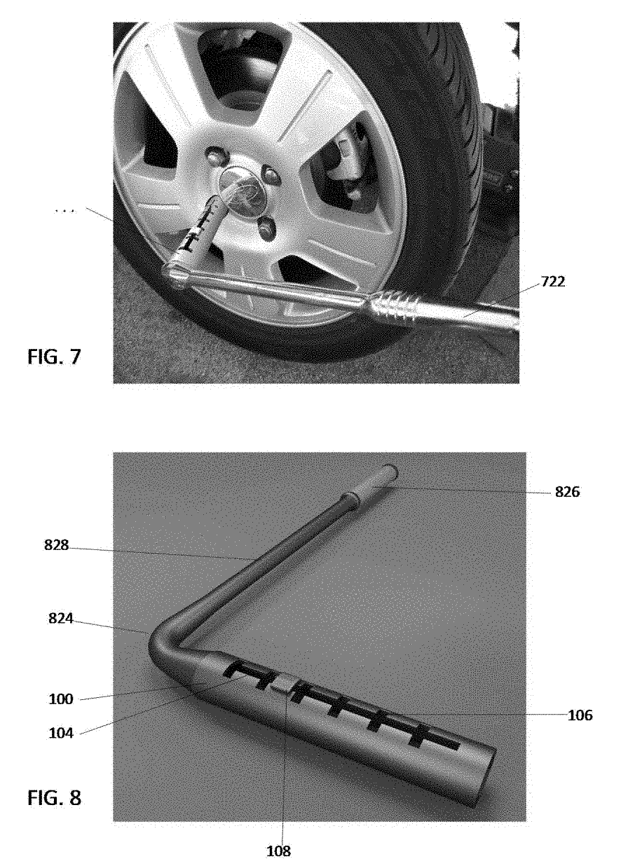

FIG. 7 illustrates an instance of an exemplary cylinder 100 in which a ratcheting tire tool 722 is attached to the cylinder and is the process of one of removing and attaching a lug nut. As with the discussion of FIG. 6, various devices and methods may be used on conjunction with the cylinder 100 to remove and attach lug nuts from a wheel.

The ratcheting tire tool 722 is depicted in FIG. 7 as engaging in such lug nut removal or attachment activity. The ratcheting tire tool 722 attaches to the cylinder 100 via the opening 212 in an end of the cylinder 100 opposite the socket.

FIG. 8 illustrates an instance of an exemplary cylinder 100 in which a tire iron 824 is built onto the cylinder 100. The tire iron 824 exhibits a handle 826 with a rubberized, textured sleeve attached to a long, hard shaft 828.

As with the air impact wrench 620 and the ratcheting tire tool 722, the permanently attached tire iron 824 allows a user to remove and attach lug nuts. The flexibility of systems provided herein in accommodating the air impact wrench 620, the ratcheting tire tool 722, and the tire iron 824 may give the cylinder 100 greater exposure and commercial success in both consumer and motor vehicle care professional markets.

The cylinder 100 accepts lug nuts continuously in their removal and helps apply lug nuts to a replacement tire. The cylinder 100 allows the user to move individual lug nuts forward for successive application. It reduces risk of misplacement and loss of lug nuts and may reduce damages to tire rims that can occur when missing a lug nut. The cylinder 100 may reduce damages to wheel hubs that can occur when missing a lug nut. It may reduce damages to vehicle alignment that can occur when missing a lug nut. The cylinder 100 may reduce risk of loss of driver control when driving a vehicle with tire that is missing a lug nut and may reduce the time needed to replace a tire.

With the cylinder 100, the user does not have to touch lug nuts as the user removes them from the cylinder 100. The user doesn't have to store the lug nuts during the tire change, and doesn't have to hunt them down when applying the spare. After the cylinder 100 removes a lug nut, the device retains that nut within its chamber 102. Each lug nut that is removed pushes the previously-removed lug nuts further within the chamber 102 for safe storage. When the user is ready to put on the spare, the lug nuts are already there within the cylinder 100. After each one is applied, the next lug nut is in position to be applied.

By reducing the time required to change an automobile tire, the cylinder 100, which may be known commercially as the “Lug Pro”, may reduce the stress caused by flat tires and their correction. By reducing the time required to change an automobile tire, the cylinder 100 may reduce user exposure to elements, such as heat, rain and snow, during the process. By reducing user exposure to elements, the cylinder 100 may reduce user risk of health ailments that can be incurred due to said exposure to elements. By reducing the time required to change an automobile tire, the cylinder 100 may reduce user risk to other maladies. The cylinder 100 may reduce user risk to being struck by another motor vehicle.

The cylinder 100 can be made of various materials that are of applicable durability and that allow intended operation of all components, such as metals that include but are not limited to tool steel, chrome molybdenum steel, and carbon steel. Various plastics may also be used in the production of the cylinder 100 such as but not limited high-density polyethylene (HDPE), polyamide-imide (PAI), and polychlorotrifluoroethylene (PCTFE). The cylinder 100 may also use both metals and plastics, and in any combination of those specified as well as others.

The cylinder 100 can be made in many variations that simply store lug nuts within the chamber 102, and that may or may not attach to a lug wrench for application and removal of lug nuts. In such variations that are not intended for application and removal of lug nuts, the nut-hosting chamber 102 may or may not have an attached cap, and to prevent its contents from falling out, and may or may not feature a bracket for attachment of the chamber 102 upon a lug wrench or upon a car jack. All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

The cylinder 100 can be made in different sizes to accommodate the common lug-nut sizes used on motor vehicles, such as but not limited to seventeen, nineteen and twenty-one millimeters, and three-quarters, thirteen-sixteenths, and seven-eighths of an inch (17 mm, 19 mm, 21 mm, ¾″, 13/16″, ⅞″). The cylinder 100 can be made in variations that accommodate different quantities of lug nuts.

The base of the cylinder 100 socket may be made of a chrome molybdenum steel in open cylindrical format, measuring approximately six inches in length by one inch in exterior diameter (6″×1″), and to safely accommodate hosting of five (5) units of standard, non-decorative lugs.

The interior diameter of the cylinder 100 may be three-quarters of an inch (¾″), with hexagonal-shaped aperture at one (1) end for acceptance of lugs. The opposite length-end of the cylinder 100 features an aperture for application of the structure upon a tire iron.

One (1) sidewall of the cylinder 100 features an open slot of approximately five inches (5″) in length, with rectangular-shaped extensions at one-inch (1″) intervals along this slot.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing removal, storage and attachment of lug nuts according to the present invention will be apparent to those skilled in the art. Various aspects of the invention have been described above by way of illustration, and the specific embodiments disclosed are not intended to limit the invention to the particular forms disclosed. The particular implementation of the design for devices for removing, storing and attaching lug nuts may vary depending upon the particular context or application. By way of example, and not limitation, the cylinder may store a plurality of lug nuts and provide a chamber of variable size for storage; however, similar techniques may instead be applied to any type of device that would benefit from such a structure, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A tool, comprising:
an open cylinder;
a socket at a first end of the cylinder;
a square-shaped opening at a second end of the cylinder;
a lengthwise chamber inside the cylinder with dimensions of the socket;
an open slot lengthwise along the cylinder;
a plurality of rectangular open slots disposed perpendicularly along the lengthwise open slot;
a pushing mechanism disposed inside the chamber;
a tab disposed to join the pushing mechanism for setting a position of the pushing mechanism; and
at least one ball bearing disposed inside the chamber proximate the first end,
whereby the socket is in a shape of a wheel lug nut and is directed to removing and attaching said lug nut, and
whereby the cylinder holds a plurality of said lug nuts at least during changing of at least one tire of a vehicle.

2. The tool of claim 1, whereby said tool is constructed from at least one of metal and plastic.

3. The tool of claim 2, whereby said tool holds the plurality of said lug nuts securely via the pushing mechanism and the at least one ball bearing.

4. The tool of claim 3, whereby the at least one ball bearing is spring loaded into the chamber and prevents stored lug nuts from falling out of the first end.

5. The tool of claim 4, whereby a sliding plate component of the pushing mechanism restricts movement of lug nuts inside the chamber.

6. The tool of claim 5, whereby the plate component is perpendicular to chamber surfaces and is moveable inside the chamber in accordance with a quantity of lug nuts inside the chamber.

7. The tool of claim 6, whereby the plate component applies pressure against the lug nuts stored inside the chamber.

8. The tool of claim 7, whereby the plate component applies the pressure via a spring inside the chamber.

9. The tool of claim 8, whereby the plate component is held in position via the tab and the spring.

10. The tool of claim 9, whereby the tab, when depressed, promotes movement of the plate component within the chamber.

11. The tool of claim 10, whereby movement of the plate within the chamber extends and shortens depth of the chamber.

12. The tool of claim 11, whereby depth of the chamber as set by the tab and the plate component depends on a quantity of lug nuts disposed inside the chamber.

13. The tool of claim 12, whereby the tab is positioned partially outside the cylinder on the lengthwise open slot and extends through the open slot to maintain contact with the plate component.

14. The tool of claim 13, whereby the tab holds the plate component in place via placement of the tab in one of the rectangular open slots.

15. The tool of claim 14, whereby the square hole accommodates placement of one of a tire iron, an air impact wrench, and a ratchet.

16. The tool of claim 15, whereby the socket attaches to lug nuts during removal from the wheel and detaches from the lug nuts after attachment to the wheel.

17. The tool of claim 16, whereby during removal, lug nuts fill the chamber and necessitate the plate component and the tab to be moved away from the first end.

18. The tool of claim 17, whereby at least one rubber strip is embedded into an exterior surface of the tool to provide grip to a user.

19. A system comprising:
a means for removing a lug nut from a wheel;
a means for storing a plurality of lug nuts in a single secure chamber of a cylinder;
a means for adjusting dimensions of the chamber in accordance with a quantity of stored lug nuts;
a means for dispensing the stored lug nuts when reattaching the stored lug nuts to the wheel; and
a means for attaching one of a tire iron, an air impact wrench, and a ratchet to the cylinder to promote removal and attachment of lug nuts from and to the wheel.

20. A system, consisting of:
a cylinder with a hollow chamber;
a hexagonal socket at a first end of the cylinder leading to the chamber, wherein the chamber is similarly shaped;
an opening at a second end of the cylinder promoting attachment of an external device comprising one of a tire iron, an air impact wrench, and a ratchet;
an open slot lengthwise along the cylinder and a plurality of rectangular open slots disposed perpendicularly along the lengthwise open slot;
a pushing mechanism comprising a sliding plate and a spring disposed inside the chamber and a tab attached to the sliding plate and spring and protruding up through the lengthwise open slot; and
at least one ball bearing disposed inside the chamber proximate the first end,
whereby the socket is in a shape of a wheel lug nut and is directed to removing and attaching said lug nut, and
whereby the cylinder holds a plurality of said lug nuts at least during changing of at least one tire of a vehicle,
whereby said cylinder is constructed from at least one of metal and plastic,
whereby said cylinder holds the plurality of said lug nuts securely via the pushing mechanism and the at least one ball bearing,
whereby the at least one ball bearing is spring loaded into the chamber and prevents stored lug nuts from falling out of the first end,
whereby the sliding plate restricts movement of lug nuts inside the chamber,
whereby the plate component is perpendicular to chamber surfaces and is moveable inside the chamber in accordance with a quantity of lug nuts inside the chamber,
whereby the plate component applies pressure against the lug nuts stored inside the chamber,
whereby the plate component applies the pressure via the spring inside the chamber,
whereby the plate component is held in position via the tab and the spring,
whereby the tab, when depressed, promotes movement of the plate component within the chamber,
whereby movement of the plate within the chamber one of extends and shortens depth of the chamber,
whereby depth of the chamber as set by the tab and the plate component depends on a quantity of lug nuts disposed inside the chamber,
whereby the tab is positioned partially outside the cylinder on the lengthwise open slot and extends through the open slot to maintain contact with the plate component,
whereby the tab holds the plate component in place via placement of the tab in one of the rectangular open slots,
whereby the socket attaches to lug nuts during removal from the wheel and detaches from the lug nuts after attachment to the wheel,
whereby during removal, lug nuts fill the chamber and necessitate the plate component and the tab to be moved away from the first end, and
whereby at least one rubber strip is embedded into an exterior surface of the tool to provide grip to a user.
